(19) United States
(12) Patent Application Publication
(10) Pub. No.: US 2014/0189747 A1
(43) Pub. Date: Jul. 3, 2014

(54) RAPID MOVEMENT THROUGH AN ELECTRONIC PROGRAM GUIDE

(71) Applicant: ECHOSTAR TECHNOLOGIES L.L.C., Englewood, CO (US)

(72) Inventor: Vern Shellman, Aurora, CO (US)

(73) Assignee: ECHOSTAR TECHNOLOGIES L.L.C., Englewood, CO (US)

(21) Appl. No.: 13/731,787

(22) Filed: Dec. 31, 2012

(51) Int. Cl. H04N 21/482

(52) U.S. Cl. CPC H04N 21/482
USPC 725/52

(57) ABSTRACT

Methods and apparatus to scroll through an electronic program guide at a first and a second scroll speed are provided. While viewing an electronic program guide (EPG) output by a receiving device, a user transmits a first command to the receiving device to start scrolling the time slots in the EPG such that the EPG displays program information for future time slots. The first command causes the time slots to scroll at a first speed. The user can increase the scroll speed by transmitting another command. The time slots in the EPG cease scrolling when there is no more data to display or when the user transmits a stop scrolling command to the receiving device.

### BACKGROUND

1. Technical Field

This disclosure is generally directed to electronic program guides made available by a client device, such as set top boxes, cable boxes, digital video recorders or similar devices. In particular, methods and apparatus for rapid movement through the electronic program guide are presented.

2. Description of the Related Art

Electronic program guides (EPGs) are generally offered by broadcast providers to their subscribers to make it easier for these subscribers to navigate the large amounts of available television programming. An electronic program guide allows a user to navigate scheduling information interactively, selecting and discovering using an input device, such as a remote control or keypad.

Raw scheduling data for the electronic program guide is generally pushed or downloaded to the client device, and is updated as needed. Typically, the data provides programming information for the next seven to fourteen days.

An electronic program guide is generally visually presented on a display screen as a graphical interface, providing program information such as the title of the program, the channel that carries the program, and the time slot and duration in which the program is broadcast from the broadcast provider. Subscribers can move sequentially in time through the listing of programs on a particular channel by moving one time slot at a time, each time slot corresponding to one half hour or an hour period. Certain user interactivity is generally supported such as selecting a program in a certain time slot for recording.

### BRIEF SUMMARY

In one embodiment of the present disclosure, a method for rapid movement through an electronic program guide is disclosed. The method includes presenting an electronic program guide as a graphical user interface on a display device associated with a client device, the electronic program guide including a first section and a second section, the first section having at least one channel identifier and the second section having a first plurality of time slots and a first arrangement of programming information associated with the first plurality of time slots [changed globally, sans redlining]. The method further includes receiving a first command from a user via a remote control, and upon receiving the first command, continuously right scrolling the second section of the electronic program guide at a first controlled scroll speed. The speed at which it scrolls is sufficiently slow that each programming information in the program cells can be read as it scrolls. The scrolling continues on a constant basis after the first command is received. The method also includes receiving a second command that is distinct and separate from the first command. Upon receiving the second command, ceasing right scrolling the second section.

In one aspect of the embodiment, the first command is carried out by the user making two depressions of a RIGHT ARROW button on the remote control in quick succession. This starts the right scrolling at a controlled speed. At some later time, when the user wishes to stop the scrolling, the user inputs a second command. The second command is carried out by the user making one depression of the RIGHT ARROW button on the remote control. In another aspect of this embodiment, the second command that stops the scrolling is a status message indicating that there is no more data available for display of programming information in the second section of the electronic program guide.

Yet another embodiment of the present disclosure is an electronic program guide controller that includes a first storage section for storing electronic program guide data and a processing section configured to generate an electronic program guide as a graphical user interface having a first section and a second section, the first section having at least one channel identifier and the second section having a first plurality of time slots and a first arrangement of programming information associated with the first plurality of time slots. The processing section is further configured to process a first command from the remote control, and upon processing the first command, cause continuous scrolling of the second section of the electronic program guide at a first controlled scroll speed. The processing section is also configured to process a second command that is distinct and separate from the first command; and upon processing the second command, cease scrolling the second section.

In one aspect of this embodiment, the processing section is configured to cease scrolling the second section when a time slot associated with a current time is presently displayed in the second section of the electronic program guide. In another aspect of this embodiment, the processing section is configured to cease scrolling the second section upon processing a message indicating that there is no more data for display of programming information in the second section of the electronic program guide.

### BRIEF DESCRIPTION OF THE SEVERAL VIEWS OF THE DRAWINGS

FIG. 1 illustrates an exemplary system in which an embodiment of rapid movement through the EPG may be implemented.

FIG. 2 illustrates some exemplary buttons on a remote control.

FIG. 3 illustrates an exemplary electronic program guide as displayed on a display device

FIGS. 4A, 4B, and 4C illustrate a set of screen shots of an electronic programming guide before, during and after a continuous scrolling.

FIGS. 5A, 5B, and 5C illustrate another set of screen shots of an electronic programming guide during and after another continuous scrolling.

FIG. 6 is a flowchart showing an exemplary process for the rapid movement through an EPG.

FIG. 7 is flowchart showing another exemplary process for the rapid movement through an EPG.

### DETAILED DESCRIPTION

In the following description, certain specific details are set forth in order to provide a thorough understanding of various embodiments of the disclosure. However, one skilled in the art will understand that the disclosure may be practiced without these specific details. In some instances, well-known interfaces associated with audio and video have not been described in detail to avoid obscuring the description of the embodiments of the present disclosure.

Unless the context requires otherwise, throughout the specification and claims that follow, the word “comprise” and variations thereof, such as “comprises” and “comprising” are to be construed in an open, inclusive sense, that is, as “including, but not limited to.”

Reference throughout this specification to “one embodiment” or “an embodiment” means that a particular feature, structure, or characteristic described in connection with the embodiment is included in at least one embodiment. Thus the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the drawings, identical reference numbers identify similar features or elements. The size and relative positions of features in the drawings are not necessarily drawn to scale.

The terms “electronic program guide,” “electronic programming guide,” or “EPG” as used herein are meant to encompass a graphical user interface (GUI) presented to a user or subscriber on a display device and the underlying functional components and data needed for its functionality in presenting program information in the context of a television broadcast system. Therefore, the term electronic program guide is used broadly in this disclosure to make the description cleaner and more straightforward without creating limitation.

The term “programming information” in the context of this disclosure includes at least a title of the program. In some embodiments, it may also include a brief description of the program, a release year, and a list of actors.

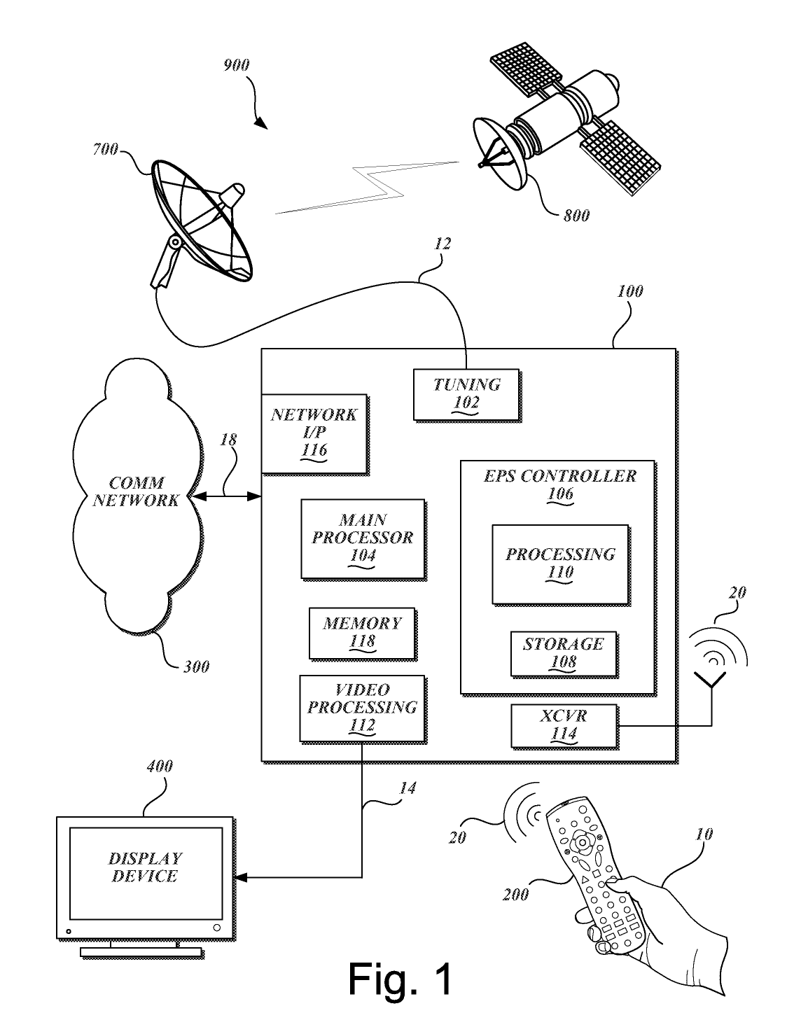

FIG. 1 is a block diagram of a system in which one embodiment of the rapid movement through EPG may be implemented. In FIG. 1, the various components comprised in the system are represented by functional blocks. The system 900 may include a client device 100, a display device 400, and a remote control 200. A user 10 uses the remote control 200 to communicate with and control client device 100 over a wireless communication link 20. In a preferred embodiment, the wireless communication link 20 is a radio frequency communication link, and the communication between client device 100 and remote control 200 are compliant with a radio frequency communication standard such as ZigBee, Wi-Fi, Bluetooth and NFC. In other embodiments, other wireless communication links and protocols, such as Infrared IrDA, may be used. Cable system 14 carries video signal from client device 100 to display device 400 over an analog or digital cable. In a preferred embodiment, cable system 14 is an HDMI cable. It is also contemplated that the cable system 14 be a composite video, component video or SCART. Other types of links suitable to carry video signal may also be used as the cable system 14.

Client device 100 may receive programming contents from various broadcast service providers, such as a satellite broadcast service provider or a cable service provider. In a preferred embodiment, client device 100 receives encrypted direct broadcast signals from a satellite 800 through an antenna 700. EPG data may be provided to client device 100 together with programming contents by a service provider.

The communication network 300 includes the service provider of the programming content and EPG data. Since communication network 300 is well known in the art, details of how it operates to provide programming contents to the client device 100 via some acceptable link, such as satellite, cable, or internet, are not shown. The client device 100 can interact with the communication network 300 directly via telephone lines, the internet, the satellite, or their combination.

Other means of delivery of EPG data, such as through the internet, through telephony line, or separately transmitted on a broadcast signal, are also contemplated. In a preferred embodiment, EPG data is transmitted together with programming contents over a satellite signal transmission from a broadcast service provider. Communication network 300 for a broadcast satellite service may includes a head end with a server to process and transmit contents, EPG data, and other information over a transponder to satellite 800 which in turn may broadcast the signal to be received by antenna 700.

Client device 100 may include a tuning section 102, a receiving section 114, a video processing section 112, a main processor 104, and an EPG controller 106. EPG controller 106 may be implemented together with main processor 104. Client device 100 may also include a network interface 116.

Main processor 104 may be configured to oversee the interaction between the elements of client device 100. Main processor 104 may also be configured to decode the transmissions from remote control 200 received by the receiving section 114 to determine which button or buttons on remote control 200 were pressed by user 10, thus what command was transmitted to client device 100. Main processor 104 may be further configured to forward the command to the EPG controller 106.

Tuning section 102 may be configured to select a specific channel or content from the broadcast signal received from antenna 700 over cable 12. EPG data transmitted over a broadcast signal may be extracted by tuning section 102 and stored in storage section 108. It is also contemplated that EPG data is received by client device 100 from network 300 over cable 18 through network interface 116, and stored in storage section 108. Network interface 116 may include an RJ45 socket, RJ11 socket, other modular socket or other standard network socket.

EPG controller 106 may include a processing section 110 and a storage section 108. The EPG controller 106 can be a part of, and be within, the main processor 104, or be a separate controller. The processing section 110 may be configured to execute an instructions set that causes a display of a graphical user interface of the EPG, and accepts a user's interaction with the graphical user interface. The instruction set may be implemented as hardware or as a software program stored in memory 118. Memory device 118 may be a Flash or RAM.

Memory 118 may also store instructions sets for the main processor 104. Upon receiving a decoded command from the main processor 104, the processing section 110 may be further configured to carry out the operation associated with the decoded command. The processing section 110 may be configured to output a video signal containing a graphical user interface (GUI) of the EPG to video processing section 112 for output to display device 400. The processing section 110 may be further configured to detect when the GUI is presenting EPG data for the current time or current time period, which indicate that the GUI is at HOME. A status message indicating that the GUI is at HOME may be provided by the processing section 110. Other means to indicate that the GUI is at HOME, such as generating a physical signal, triggering an interrupt or setting a bit in a register are also contemplated.

EPG data stored in storage section 108 may include a database of information on a number of programming contents, and the information for each programming content may include the title or name of the programming content, the associated channel identifiers, descriptions, date of availability, start and end times, ratings, or actors or participants in the programming content. The storage section 108 may also be configured to monitor the amount of available data and the status of the data. A client device 100 may be provided with and have stored therein many days of programming information as EPG data, with updates for programming information for upcoming days sent from the communication network 300 or satellite 800. In one embodiment, the EPG stores 14 days of programming information. Each day, or a few times a day, the EPG data is updated to include any changes to the upcoming programming contents. Storage section 108 stores the latest updates to the stored EPG data. Storage section 108 may also generate various status messages, such as an “OUT OF DATA” status message that indicates that data is not available for a time slot selected, or that there is no more data for display in an EPG. In a preferred embodiment, an “OUT OF DATA” status message is generated when user 10 has browsed or scrolled to a time slot in the future for which EPG data for programming information is not available for display. In another embodiment, an “OUT OF DATA” status message is generated when user 10 has browsed or scrolled to a time slot in the past beyond which EPG data for programming information is not available for display. Instead of generating a physical signal, setting a status bit in a register is also contemplated. In another embodiment, transmission of a null or garbage as data may also constitute a status signal indicating no more EPG data is available for display.

Video processing section 112 may be coupled to EPG controller 106 and may be configured to format a signal from EPG controller 106 for display on display device 400.

Receiving section 114 may be coupled to the main processor 104 and to EPG controller 106. Receiving section 114 may be configured to receive transmission from remote control 200 over wireless communication link 20. In a preferred embodiment, the wireless communication link 20 is a radio frequency interface such as ZigBee and Wi-Fi. Transmission from remote control 200 carries a representation of a user's actuation of a button on remote control 200. Receiving section 114 forwards the received transmission from remote control 200 to main processor 104 for processing and/or decoding. Main processor 104 passes the decoded command to the processing section 110 in the EPG Controller 106.

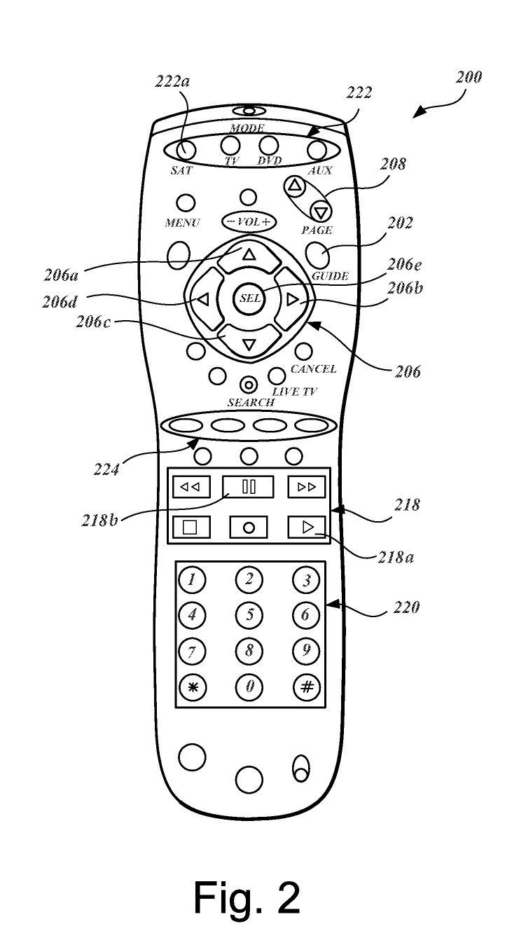

In one preferred embodiment, user 10 wishes to view an electronic program guide on display device 400 by actuating a button on remote control 200. FIG. 2 illustrates some buttons on an exemplary remote control 200. Remote control 200 may have MODE buttons 222 for placing the remote control 200 in an appropriate mode to communicate with a certain device. To communicate with client device 100, remote control 200 is placed in SAT mode, short for satellite, by selecting SAT mode button 222a. Pressing the TV mode button places the remote control 200 in a TV mode and subsequent button presses control the TV. Similarly, pressing the DVR mode button puts the remote control 200 in a DVR mode. Remote control 200 may also have PAGE buttons 208 to page up and down through a menu or guide, and ARROW/SELECT buttons 206. These buttons are used to navigate through menus and graphical user interfaces and to select a desired option in SAT mode. The ARROW/SELECT buttons 206 preferably include an UP ARROW button 206a, a RIGHT ARROW button 206b, a DOWN ARROW button 206c, a LEFT ARROW button 206d, and a SELECT button 206e. Remote control 200 may also have NUMBER buttons 220 for entering channel numbers or navigate through menus or program guide in SAT mode, a GUIDE button 202 for invoking a display of current and future satellite program listing. In a preferred embodiment, actuating the GUIDE button 202 invokes the display of the EPG on display device 400 as a graphical user interface (GUI). Remote control 200 may also include DVR buttons 218 to pause (using PAUSE button 218b) and playback (PLAY button 218a) live TV while the remote control 200 is in the SAT mode, and SPECIAL FUNCTION buttons 224 to provide shortcuts to frequently used menus.

More or different buttons may be provided on exemplary remote control 200 to enable user communication with client device 100 as is well known in the art. Alternative methods for user communication with client device 100 such as a remote control with different buttons or different button layouts, a touch pad or a keyboard device may be used.

Referring back to the system illustrated in FIG. 1, in the preferred embodiment, user 10 presses the GUIDE button 202 on remote control 200 to bring up an electronic program guide (EPG) on display device 400. To scroll at a preset, controlled speed through the program information in the EPG, user 10 presses the RIGHT ARROW button 206b twice in quick succession. The main processor 104 decodes this transmission from remote control 200 as a command for continuous right scrolling at a slow, controlled speed and proceeds to instruct the processing section 110 to carry out the command, to advance the EPG GUI to the right, thus displaying future time slots with future program information. Upon receiving the instruction, the processing section 110 causes a section of the EPG GUI that contains time slots and program information to continuously right scroll, traversing the time slots into a time in the future at a controlled rate sufficiently slow that a user can read each program information for a brief moment. The processing section 110 also causes another section of the EPG GUI that contains channel identifiers to remain stationary. If user 10 presses the RIGHT ARROW button 206b twice in quick succession for the second time, main processor 104 decodes this transmission from remote control 200 as a command to increase the rate of the continuous right scrolling and instructs the processing section 110 to cause a faster continuous right scrolling of the section of the EPG GUI that contains time slots and program information.

In one embodiment, the first scroll speed is set such that each time slot on the EPG remains in view for 1-2 seconds. This will give sufficient time for a user to clearly read the program information in the time slots. The second scroll speed may set such that each time slot on the EPG remains in view for 0.5-1 second, which is much faster, but still at a rate that can be read by a user who pays careful attention to the EPG.

In the preferred embodiment, when user 10 presses the RIGHT ARROW button 206b once during the continuous right scrolling, main processor 104 decodes this transmission from remote control 200 as a command to cease the continuous right scrolling and instructs the processing section 110 to do so. The processing section 110 may also be configured to cease the continuous right scrolling when the LEFT ARROW button 206d is pressed once or when it detects or receives a status message from storage section 108 indicating that there is no more EPG data available to populate the EPG GUI for display.

In another preferred embodiment, user 10 presses the LEFT ARROW button 206d twice in quick succession, and main processor 104 decodes this transmission from remote control 200 as a command for continuous left scrolling and instructs the processing section 110 to carry out the command. Upon receiving the instruction, the processing section 110 causes the section of the EPG GUI that contains time slots and program information to continuously left scroll, traversing previous time slots while keeping the section of the EPG GUI that contains channel identifiers stationary. If user 10 presses the LEFT ARROW button 206d twice in quick succession for the second time, main processor 104 decodes this transmission from remote control 200 as a command to increase the rate of continuous left scrolling, and main processor 104 instructs the processing section 110 to cause a faster continuous left scrolling of the section of the EPG GUI that contains time slots and program information.

When user 10 presses the LEFT ARROW button once during the continuous left scrolling, the main processor 104 decodes this transmission from remote control 200 as a command to cease the continuous left scrolling of the section of the EPG GUI that contains time slots and program information. The processing section 110 may also be configured to cease the continuous left scrolling on other button press or when it detects or receives a status message from storage section 108 indicating that there is no more EPG data available to populate the EPG GUI for display. When the EPG GUI is at HOME, the processing section 110 may also cease the continuous left scrolling.

One skilled in the art understands that client device 100 as illustrated in FIG. 1 may include more elements and functionalities. The elements of client device 100 may be implemented in hardware, software, firmware and combinations thereof. Some elements may also be combined or separate, in more specialized elements.

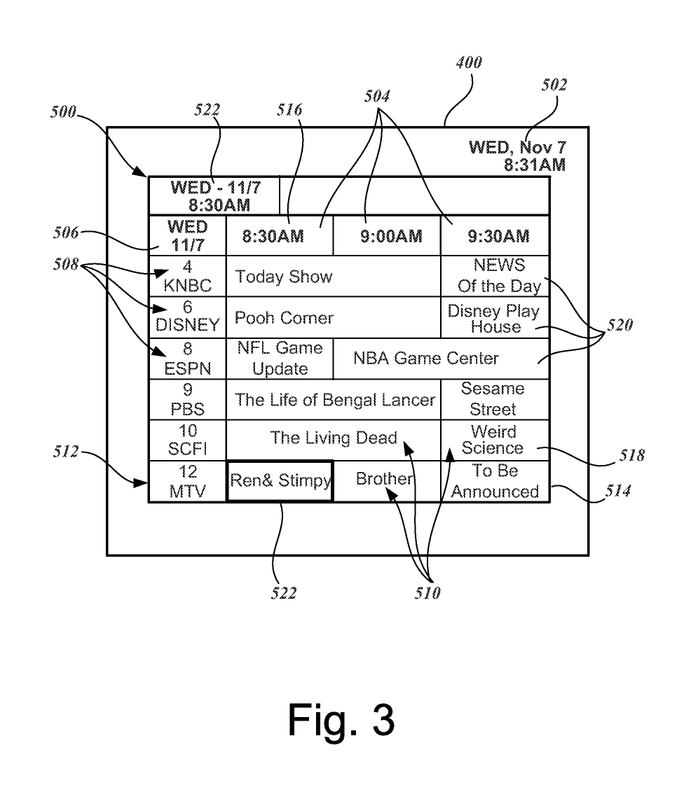

FIG. 3 illustrates an exemplary electronic program guide (EPG) displayed as a graphical user interface (GUI) on a display device of a type well known in the prior art. Electronic program guide 500, or EPG 500, refers to the EPG as a GUI displayed on a display device. EPG 500 may be invoked when a user presses the GUIDE button 202 on the remote control 200. EPG 500 typically includes one or more items of program information, such as a program title, and scheduled start and end time of a programming. It may also include a textual program summary, a program rating, etc. In a preferred embodiment, EPG 500 is displayed on a display device as a two-dimensional grid, with a plurality of channel identifiers 508 displayed along a vertical dimension and a plurality of time slots 504 displayed along a horizontal dimension. For example, the electronic program guide 500 may, at any one time, display six channel identifiers 508 vertically arranged in increasing order of channel number, and for each displayed channel identifier, a horizontal arrangement of program information that will be carried by that channel during the next ninety minutes or two hours.

In FIG. 3, EPG 500 as displayed on a display screen of a display device 400 includes a first section 512 and a second section 514. The elements identified in FIG. 3 are presented for example purposes only and it is understood that more or less elements may be included in the graphical user interface presentation of an electronic program guide. In some embodiments, EPG 500 may include another section for display of a video stream.

The first section 512 shows at least one channel identifier 508 at any one time. In a preferred embodiment, the first section 512 shows six channel identifiers, but a display of more or less number of channel identifiers in the first section 512 at any one time is contemplated. The second section 514 includes a plurality of time slots 504. Each time slot 504 may be a thirty minute or a one hour time period. In a preferred embodiment, the second section 514 includes at least three time slots, although more or less time slots in the second section 514 are contemplated. Some televisions or display devices show three thirty minute time slots, while others show six or seven of such time slots.

EPG 500 may also include a current day/date 506. A current time 502 may be displayed in a region on the display screen of the display device 400, outside the EPG 500. A “current time slot” is a time slot which period encompasses the current time. In FIG. 3, time slot 516 is the “current time slot” because its thirty minute period between 8:30 AM and 9:00 AM encompasses the current time 502 of 8:31 AM. EPG 500 may also include an EPG day/date/time 524 that indicates the day, date and time for which the EPG 500 starts the display of program information under their respective time slots. In FIG. 3, EPG 500 starts the display of program information for Wednesday, November 11 at 8:30 AM.

A row for each channel identifier 508 may be sectioned by the plurality of time slots 504 into a plurality of program cells 520, and program information 510 may be presented in each of the program cells 520, indicating the availability of the programming content associated with the program information for viewing and/or recording. As an example, in FIG. 3, the program information “WEIRD SCIENCE” in program cell 518 indicates that the programming content “WEIRD SCIENCE” will be available during the time slot 9:30 AM to 10 AM at channel “10 SCIFI.” Program information 510 may be a title of the programming content, but more information may be displayed as program information in each of the program cells 520.

User 10 may navigate through the EPG 500 and select a particular cell by moving a selection indicator 522. The selection indicator 522 may be a cursor or other means for highlighting a selection such as displaying the selected program cell in a different color or prominently outlining, or drawing a box around, the selected cell. User 10 may move the selection indicator 522 using the ARROW buttons on the remote control 200. In a preferred embodiment, user 10 uses the ARROW keys 206 to move the selection indicator 522 through EPG 500. Once the selection indicator 522 is placed on a desired cell, a selection may be made by pressing the SELECT button 206e on remote control 200. Actuating a button is defined for the purpose of this disclosure as a deliberate depressing and releasing of a button.

User 10 may traverse the multiple time slots 504 using ARROW buttons 206 on remote control 200. In a preferred embodiment, user 10 uses the RIGHT ARROW button 206b and LEFT ARROW button 206d on remote control 200 to move the selection indicator 522 in the horizontal direction, to left or right accordingly. The number of time slots 504 available for browsing by user 10 may depend on the amount of EPG data available in a client device 100. In a preferred embodiment, there are fourteen days' worth of EPG data in the client device 100.

Each actuation of the LEFT ARROW button 206d or RIGHT ARROW button 206b moves the selection indicator 522 one time slot to the left or to the right. To move through the next five time slots, user 10 presses the RIGHT ARROW button 206b five times. Each time slot traversed with each actuation of the LEFT ARROW button 206d or RIGHT ARROW button 206b may be a thirty minute time slot or a one hour time slot. Given the large number of time slots available for browsing, it may be inefficient for user 10 to move the selection indicator 522 only one time slot at a time. To traverse the time slots faster or to quickly scroll across the time slots, user 10 may use certain button or buttons on the remote control 200 to continuously scroll the second section 514 of EPG 500.

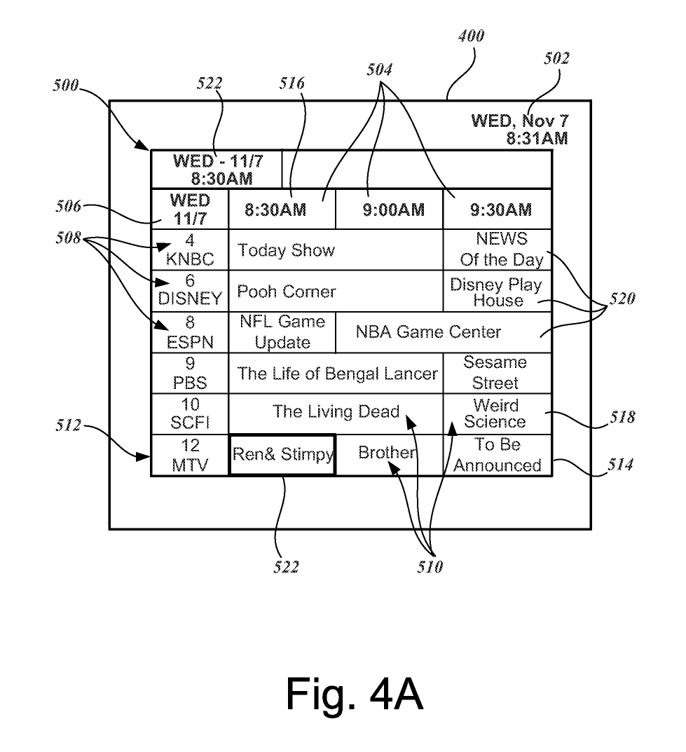

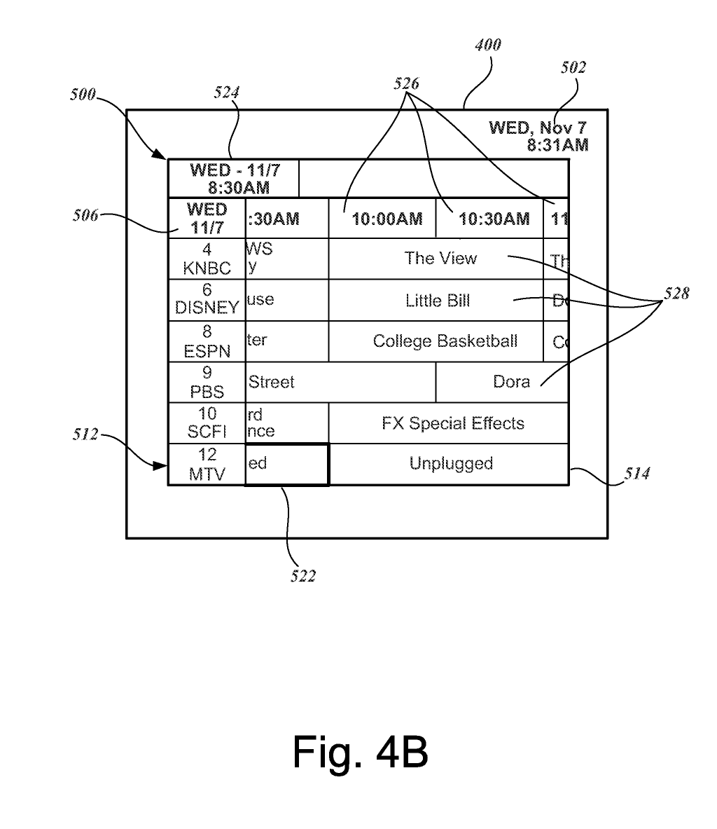

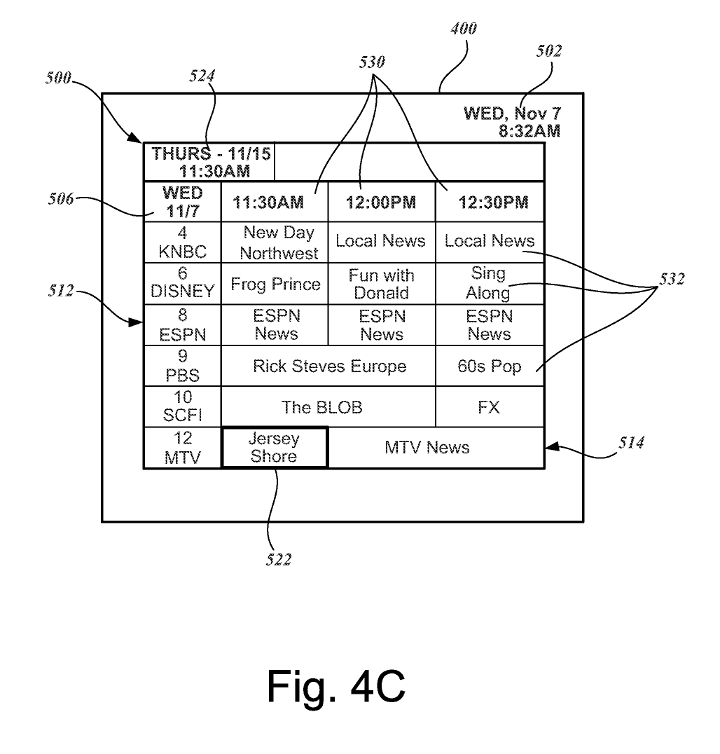

FIGS. 4A, 4B and 4C illustrate a set of screen shots of the EPG 500 before, during and after a continuous scrolling. FIG. 4A illustrates an initial view of EPG 500 before any user input for continuous scrolling is received. The current day/date 506 reflects the day and date EPG 500 is being viewed, and the time slots 504 includes the current time slot 516. In this initial view, the selection indicator 522 highlights or selects the program cell containing the program information “REN & STIMPY” on the bottom left corner of the EPG 500. The current time 502 indicates 8:31 AM.

In a preferred embodiment, pressing the RIGHT ARROW button 206b two times in quick succession causes the entire second section 514 as viewed in the EPG 500 to continuously scroll towards the right, allowing user 10 to view the upcoming time slots and program information in a scrolling manner. The term “right scroll” as used herein refers to the effect of the user scrolling to the right to see future programs, although the program listings themselves moves from right to left. Because the entire second section 514 as viewed, and thus the program cells 520, scrolls to the right, the selection indicator 522 will effectively highlight new program cells without itself moving to the right. FIG. 4B illustrates the result of the continuous right scrolling of the second section 514 as viewed in the EPG 500 upon the user pressing the RIGHT ARROW button 206b twice in quick succession. During the continuous right scrolling, the first section 512 of EPG 500 may remains stationary. As the second section 514 scrolls to the right, “newer time slots” 526 appear on EPG 500 as do “newer program information” 528. The current day/date 506 remains unchanged and the selection indicator 522 continues to highlight the program cell on the bottom left corner of the EPG 500, which as illustrated in FIG. 4B, contains the program information “TO BE ANNOUNCED.”

In the preferred embodiment, user 10 causes an even faster continuous right scrolling by actuating, for the second time, the RIGHT ARROW button 206b two times in quick succession, after which, the second section 514 continuously right scrolls at a faster rate.

When user 10 sees a time slot or program information of interest, user 10 may press another button on remote control 200 to cease the continuous right scrolling. In the preferred embodiment, user 10 presses the RIGHT ARROW button 206b once to cease the continuous right scrolling of the second section 514. In other embodiments, the user presses left arrow button 206d. Upon cessation of the continuous right scrolling, user 10 is presented with the second section 514 populated with program information for upcoming time slots. User 10 may proceed to move the selection indicator 522 to an upcoming program information 510 of interest in the second section 514 if user 10 wishes to setup recording of the upcoming program, or if user 10 wishes to obtain more information of the upcoming program.

FIG. 4C illustrates a view of EPG 500 after cessation of the continuous right scrolling. In FIG. 4C, the information reflected in the EPG day/date/time 524 is updated to reflect for which day, date and time the program information are being displayed in EPG 500. In this particular example, user 10 has scrolled the second section 514 of EPG 500 to Thursday, November 15, and once the scrolling ceases, EPG 500 displays program information for time slots starting at 11:30 AM on Thursday, November 15. Current day/date 506 remains unchanged. Current time 502 may change due to the time it takes user 10 to scroll the second section 514. EPG 500 displays a set of time slots, the “future time slots” 530 and a set of program information, the “future program information” 532. In FIG. 4C, selection indicator 522 remains on the bottom left corner of the EPG 500, highlighting the program information “JERSEY SHORE.”

As previously discussed, there may be fourteen or more days' worth of programming data or EPG data in a client device 100. More or less programming data may be made available in a client device 100. Programming data or EPG data may be updated periodically or as needed. User 10 may traverse the time slots to a point in which there is no more programming data available to be presented in EPG 500. When this happens, the second section 514 will cease the continuous right scrolling since there is no more data available for presentation on EPG 500.

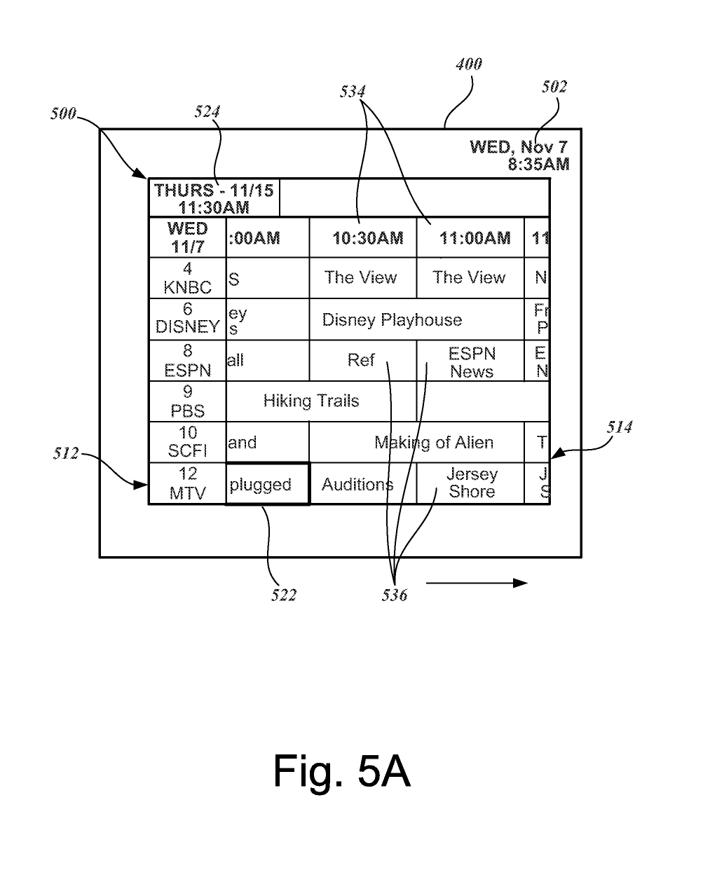

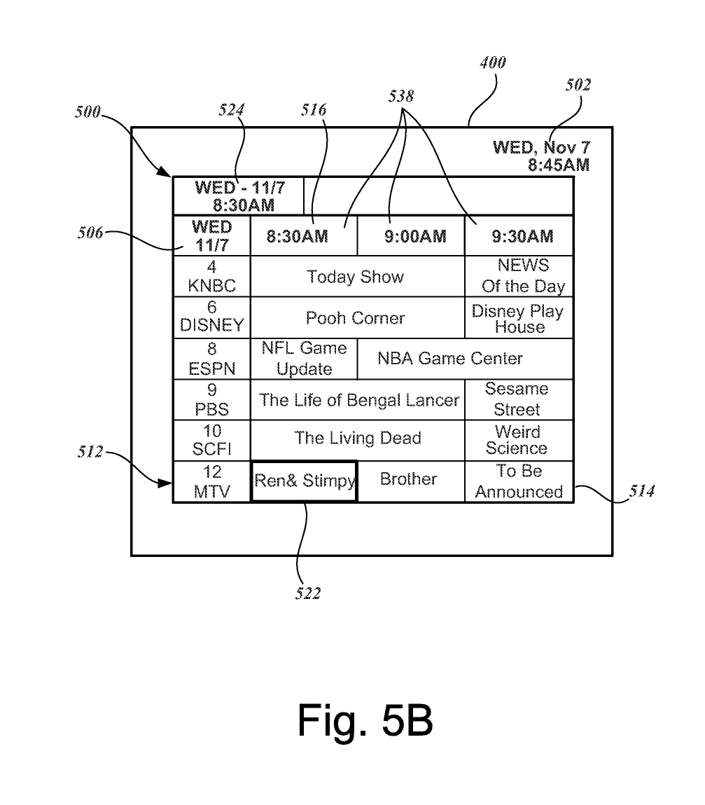

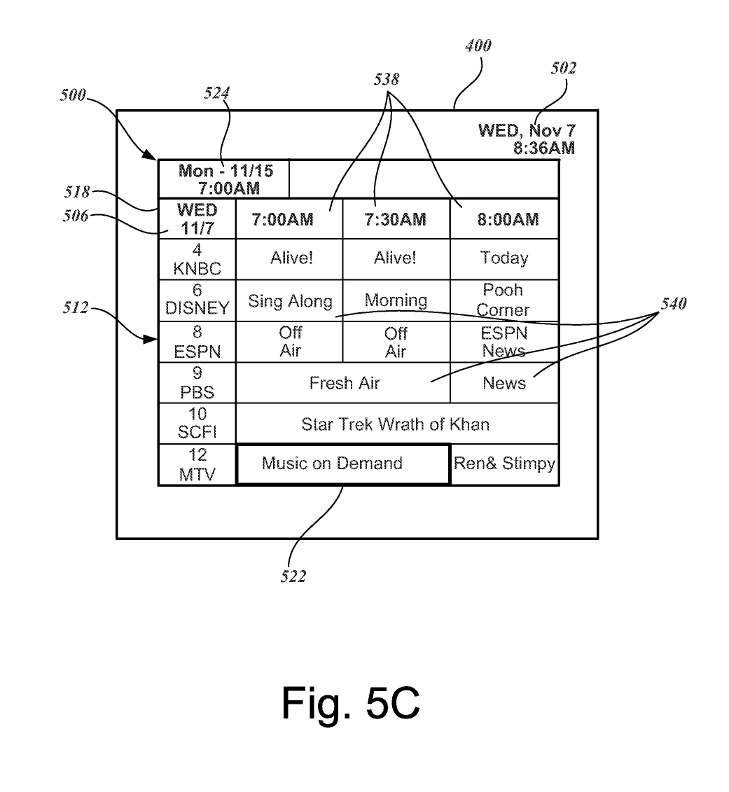

FIGS. 5A, 5B, and 5C illustrate a set of screen shots of the EPG 500 before, during and after another continuous scrolling. Having scrolled a few days into the future to see what programs are available then, user 10 may want to return to the current time slot. User 10 may traverse the time slots in the second section 514 back one time slot at a time by pressing the LEFT ARROW button 206d one time on remote control 200. Each actuation of the LEFT ARROW button 206d may move the selection indicator 522 to a program cell on its left. To traverse the time slots back faster or to quickly scroll back to the current time slot, user 10 may use certain button or buttons on remote control 200 to continuously left scroll through the time slots and program information in the second section 514 of the EPG 500. In a preferred embodiment, user 10 presses the LEFT ARROW button 206d twice in quick succession to cause the second section 514 of EPG 500 to continuously left scroll back through previous time slots and program information. Other button or buttons on remote control 200 may be designated to do the same.

FIG. 5A illustrates the second section 514 scrolling back to display earlier time slots and program information upon the actuation of the LEFT ARROW button 206d in two quick successions. Another set of time slots, the “earlier time slots” 534 and another set of program information, the “earlier program information” 536 may be displayed as the second section 514 continuously left scrolls. Earlier being relative to the time the left scrolling begins.

In the preferred embodiment, if user 10 does not cease the continuous left scrolling, the continuous left scrolling persists until HOME, or the current time, is reached. FIG. 5B illustrates EPG 500 when HOME is reached. EPG day/date/time 524 reflects the current day/date 506, and the period of the current time slot 516, between 8:30 AM-9:00 AM, encompasses the current time 502 of 8:45 AM. When HOME is reached, continuous left scrolling ceases.

EPG 500 may also display program information associated with periods earlier than the current time. User 10 may want to know of any programming content in the recent past that he or she missed. From HOME, user 10 may use certain button or buttons on the remote control 200 to cause EPG 500 to display time slots earlier than the current time slot and the programming information associated with them. In the preferred embodiment, user 10 presses the LEFT ARROW button 206d twice in quick succession to continuously left scroll to time slots earlier than the current time slot, and presses the LEFT ARROW button 206d once to cease the continuous left scrolling. It is contemplated that other button or buttons on remote control 200 may be designated to do the same. Continuous left scrolling past the current time slot may also cease when there is no more programming data or EPG data available for display in EPG 500.

User 10 may cease the continuous left scrolling past the current time slot by using certain button or buttons on remote control 200. In the preferred embodiment, user 10 presses the LEFT ARROW button 206d once to cease the continuous left scrolling past the current time slot. It is contemplated that other button or buttons on remote control 200 may be designated to do the same.

FIG. 5C illustrates the EPG 500 following cessation of the continuous left scrolling past the current time slot and into a period earlier than the current time. In FIG. 5C, an example of the current time 502 is 8:36 AM, and the current day/date 506 is Wednesday, November 7. The EPG day/date/time 524, however, may indicate Monday November 5 and 7:00 AM, and EPG 500 may display a new set of time slots, the “past time slots” 538 for time periods beginning at 7:00 AM on Monday November 5. EPG 500 may also display a new set of program information, the “past program information” 540 associated with the” past time slots” 538 as illustrated.

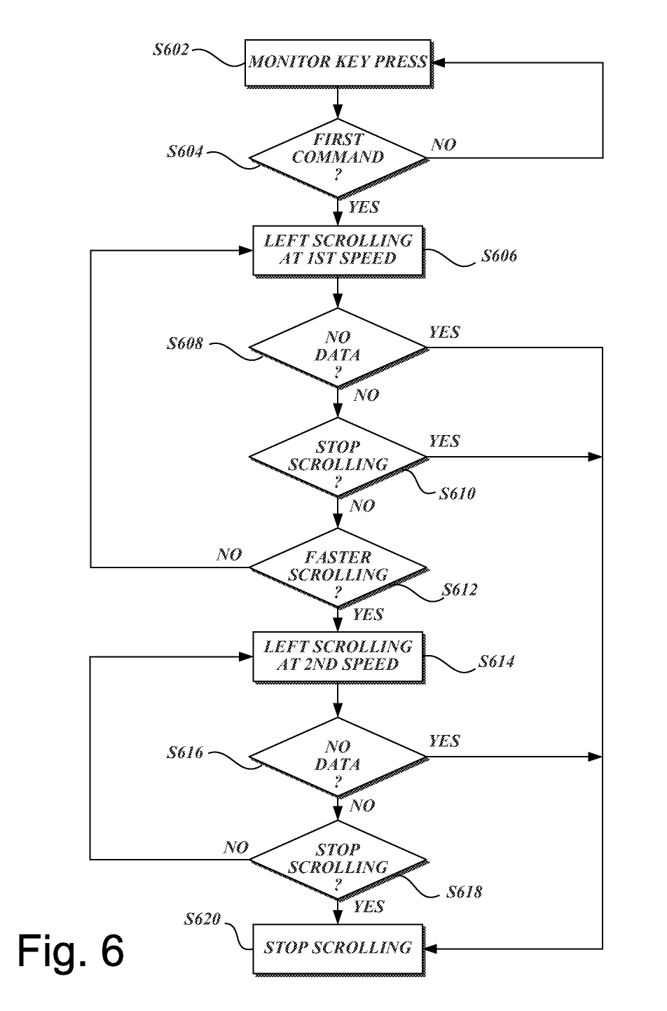

Referring to FIG. 6, a flowchart illustrating an example of a process of the current disclosure is presented. As described in earlier paragraphs, various operations of client device 100 may be controlled internally by the several elements in client devices 100, some in response to a user's command as transmitted by remote control 200. In S602, the client device 100 monitors input from remote control 200, looking for any button actuation from user 10. In S604, the EPG controller 106 may determine that it receives a first command to right scroll the second section 514 of EPG 500. The first command is preferably received from a user via remote control 200 and represents the actuation of the RIGHT ARROW button 206b two times in quick succession. Upon receiving the first command, in S606 the EPG controller 106 causes the second section 514 of EPG 500 to continuously right scroll at a certain rate. When there is no more programming data available for display in EPG 500, a status message indicating such condition is generated at S608 and causes the continuous right scrolling to cease. If there is still programming data available, the second section continues to right scroll until a command from the user via remote control 200 to cease the continuous scrolling is detected at S610, subsequent to which the continuous right scrolling ceases at S620. The command to cease is preferably a single actuation of the RIGHT ARROW button 206b on remote control 200. If there is no command to cease and the EPG controller 106 receives a command from remote control 200 to increase the continuous left scroll rate at S612, the EPG controller 106 causes the second section 514 to continuously left scroll at a faster rate at S614. The command to increase the scroll rate is preferably another actuation of the RIGHT ARROW button 206b two times in quick succession. While the second section 514 is continuously right scrolling at the new faster rate, a status message indicating that there is no more programming data available for display in EPG 500 may be detected at S616, subsequent to which, the faster continuous right scrolling ceases. While the second section 514 is continuously right scrolling at the new faster rate, the EPG controller 106 may receive another command from remote control 200 to cease the continuous right scrolling at S618, subsequent to which, the faster continuous right scrolling ceases at S620. The command to cease the faster continuous right scrolling is preferably an actuation of the RIGHT ARROW button 206b once on remote control 200.

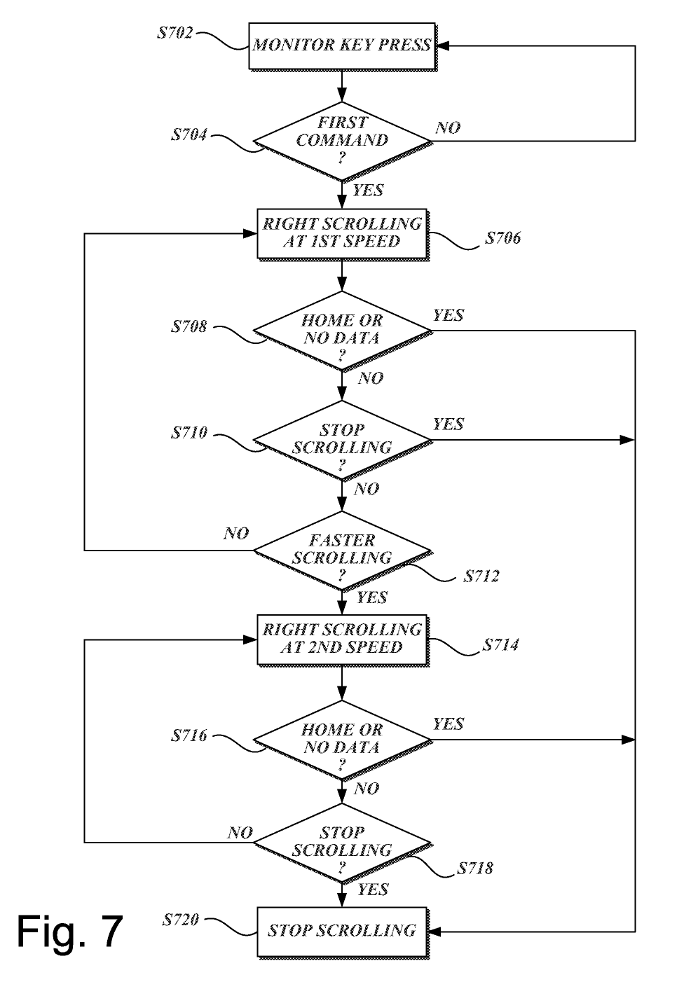

Referring to FIG. 7, a flowchart illustrating another example of a process of the current disclosure is presented. In S702, the client device 100 monitors input from remote control 200, looking for any button actuation from user 10. In S704, the EPG controller 106 may determine if it receives a first command to left scroll the second section 514 of EPG 500. The first command is preferably received from remote control 200 and represents the actuation of the LEFT ARROW button 206d two times in quick succession. Upon receiving the first command, in S706 the EPG controller 106 may cause the second section 514 of EPG 500 to continuously left scroll at a certain rate. When there is no more programming data available for display in EPG 500, a status message indicating such condition is generated at S708 and causes the continuous left scrolling to cease at S720. If there is still programming data available, the second section continues to left scroll until a command from remote control 200 to cease the continuous left scrolling is detected at S710, subsequent to which the continuous left scrolling ceases at S720. The command to cease is preferably a single actuation of the LEFT ARROW button 206d on remote control 200. As the second section 514 is continuously left scrolling, instead of a status message indicating that there is no more programming data available for display in EPG 500, a status message indicating that HOME is reached may be detected at S708, subsequent to which, the continuous left scrolling ceases.

If there is no command to cease the continuous left scrolling, the EPG controller 106 may receive a command from remote control 200 to increase the continuous left scroll rate at S712, and the EPG controller 106 may cause the second section 514 to continuously scroll at a faster rate at S714. The command to increase the scroll rate is preferably the actuation of the LEFT ARROW button 206d on remote control 200 twice in quick succession. While the second section 514 is continuously left scrolling at the new faster rate, a status message indicating that there is no more programming data available for display in the GUI may be detected in S716, subsequent to which, the faster continuous left scrolling ceases at S720. A status message indicating that HOME is reached may be detected at S716 instead of the status message indicating that there is no more programming data available for display in EPG 500, subsequent to which, the continuous left scrolling ceases.

While the second section 514 is continuously left scrolling at the new faster rate, the EPG controller 106 may detect a command from remote control 200 to cease the continuous left scrolling at S718, subsequent to which, the faster continuous left scrolling ceases at S720. The command to cease the faster continuous left scrolling is preferably an actuation of the LEFT ARROW button 206d once on remote control 200.

It is understood that the flowcharts in FIGS. 6 and 7 are for illustration only and are not intended to represent the only possible process flow. Process steps may be added, omitted, and reordered as may be suitable to a particular embodiment.

The various embodiments described above can be combined to provide further embodiments. All of the U.S. patents, U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified, if necessary to employ concepts of the various patents, application and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
presenting an electronic program guide on a display device associated with a client device, the electronic program guide including a first section and a second section, the first section having at least one channel identifier and the second section having a first plurality of time slots and a first arrangement of programming information associated with the first plurality of time slots;
receiving a first command from a user via a remote control;
upon receiving the first command, based solely on the received command and without reference to a configuration file, directly continuously right scrolling the second section of the electronic program guide at a first controlled scroll speed, the first controlled scroll speed permitting human perception of each programming information as it scrolls;
receiving a second unrelated and distinct command from the user at a user selected time after the first command; and
upon receiving the second command, based solely on the received command and without reference to a configuration file, directly ceasing right scrolling the second section.

2. The method as claimed in claim 1 wherein the first command represents two depressions of a right-arrow button on the remote control, the two depressions occurring in quick succession.

3. The method as claimed in claim 1 wherein the second command is from the remote control, the second command representing one depression of a right-arrow button on the remote control.

4. The method as claimed in claim 1 wherein the second command is a status message indicating that there is no more data available for display of programming information in the second section of the electronic program guide.

5. The method as claimed in claim 1, further comprising:
upon ceasing right scrolling, displaying a second arrangement of the programming information within a second plurality of time slots in the second section of the electronic program guide.

6. The method as claimed in claim 1, further comprising:
consecutive to receiving the first command but before receiving the second command, receiving a third command from the remote control, the third command representing two depressions of a right-arrow button on the remote control, the depressions occurring in quick succession; and
upon receiving the third command, based solely on the received command and without reference to a configuration file, directly right scrolling the second section of the electronic program guide at a second controlled scroll speed, the second controlled scroll speed being faster than the first controlled scroll speed.

7. A method, comprising:
presenting an electronic programming guide on a display device associated with a client device, the electronic program guide including a first section and a second section, the first section having at least one channel identifier and the second section having a first plurality of time slots and a first arrangement of programming information associated with the first plurality of time slots;
receiving a first command from a user via a remote control;
upon receiving the first command, based solely on the received command and without reference to a configuration file, directly continuously left scrolling the second section of the electronic program guide at a first controlled scroll speed, the first controlled scroll speed permitting human perception of each programming information as it scrolls;
receiving a second unrelated and distinct command after the first command; and
upon receiving the second command, based solely on the received command and without reference to a configuration file, directly ceasing left scrolling the second section.

8. The method as claimed in claim 7 wherein the first command represents two depressions of a left-arrow button on the remote control, the two depressions occurring in quick succession.

9. The method as claimed in claim 7 wherein the second command is received from the remote control, the second command representing one depression of a left-arrow button on the remote control.

10. The method as claimed in claim 7 wherein the second command is a first status message indicating that there is no more data for display of programming information in the second section of the electronic program guide.

11. The method as claimed in claim 7, wherein the second command is a status message indicating that a time slot associated with a current time is presently displayed in the second section of the electronic program guide.

12. The method as claimed in claim 7, further comprising:
upon ceasing left scrolling, displaying a second arrangement of programming information associated with a second plurality of time slots in the second section in the electronic program guide.

13. The method as claimed in claim 7, further comprising:
consecutive to receiving the first command but before receiving the second command, receiving a third command from the remote control, the third command representing two depressions of a left-arrow button on the remote control, the two depressions occurring in quick succession; and
upon receiving the third command, based solely on the received command and without reference to a configuration file, directly left scrolling the second section of the electronic program guide at a second controlled scroll speed, the second controlled scroll speed being faster than the first controlled scroll speed.

14. An electronic program guide controller, comprising:
a first storage section configured to store electronic program guide data; and
a processing section coupled to the first storage section and to a receiving section, the processing section configured to:
generate an electronic program guide, the electronic program guide being a graphical user interface including a first section and a second section, the first section having at least one channel identifier and the second section having a first plurality of time slots and a first arrangement of programming information associated with the first plurality of time slots;
process a first command, the first command being a first transmission from a user via a remote control;
upon processing the first command, based solely on the received command and without reference to a configuration file, directly cause continuous scrolling of the second section of the electronic program guide at a first controlled scroll speed, the first controlled scroll speed permitting human perception of each programming information as it scrolls;
process a second unrelated and distinct command after processing the first command; and
upon processing the second command, based solely on the received command and without reference to a configuration file, directly cease the continuous scrolling of the second section of the electronic program guide.

15. The electronic program guide controller as claimed in claim 14 wherein:
the first command represents two depressions of a right-arrow button on the remote control, the two depressions occurring in quick succession; and
wherein the continuous scrolling of the second section is a right scrolling.

16. The electronic program guide controller as claimed in claim 14 wherein the second command is a second transmission from the remote control, the second command representing one depression of a right-arrow button on the remote control.

17. The electronic program guide controller as claimed in claim 14 wherein:
the first storage section is further configured to generate a first status message indicating that there is no more data for display of programming information in the second section of the electronic program guide; and
wherein the second command is the first status message.

18. The electronic program guide controller as claimed in claim 14 wherein the processing section is further configured to:
process, consecutive to receiving the first command and before receiving the second command, a third command from the remote control; and
upon processing the third command, based solely on the received command and without reference to a configuration file, directly scroll the second section of the electronic program guide at a second controlled scroll speed, the second controlled scroll speed being faster than the first controlled scroll speed.

19. The electronic program guide controller as claimed in claim 14 wherein the processing section is further configured to:
upon ceasing the continuous scrolling, cause the electronic program guide to display a second arrangement of programming information associated with a second plurality of time slots in the second section.

20. The electronic program guide controller as claimed in claim 14 wherein:
the processing section is further configured to
generate a second status message when a time slot associated with a current time is presently displayed in the second section of the electronic program guide; and
upon ceasing scrolling, cause the electronic program guide to display a second arrangement of programming information associated with a second plurality of time slots in the second section, the second plurality of time slots including the time slot associated with the current time; and
wherein the second command is the second status message.
